(19) United States
(12) Patent Application Publication
(10) Pub. No.: US 2025/0368553 A1
(43) Pub. Date: Dec. 4, 2025

(54) IMPROVED HYDROGENATION OF POTABLE WATER

(71) Applicant: Ricky D. Kirk, Danville, KY (US)

(72) Inventor: Ricky D. Kirk, Danville, KY (US)

(21) Appl. No.: 18/874,825

(22) PCT Filed: Jun. 26, 2023
(86) PCT No.: PCT/US2023/069102

§ 371 Date: Dec. 13, 2024

Related U.S. Application Data
(60) Provisional application No. 63/357,255, filed on Jun. 30, 2022.

(51) Int. Cl. C02F 1/66

(52) U.S. Cl. CPC C02F 1/66

(57) ABSTRACT

Systems and methods for improved hydrogenation of water include pre-cooling hydrogen prior to delivery of the hydrogen to a hydrogen water generator and using a manifold to combine the hydrogen output of multiple hydrogen-containing storage containers into a single fluid channel prior to delivery of the hydrogen to the hydrogen water generator.

### TECHNICAL FIELD

Systems and methods for improved hydrogenation of water include pre-cooling hydrogen prior to delivery of the hydrogen to a hydrogen water generator and using a manifold to combine the hydrogen output of multiple hydrogen-containing storage containers into a single fluid channel prior to delivery of the hydrogen to the hydrogen water generator

### BACKGROUND ART

Oxidative stress indicates a state where excessive reactive oxygen species (ROS) overwhelm the biological antioxidant capacity, leading to disruption of ROS homeostasis and cellular damage. It is important for cells to maintain heathy levels of ROS to perform normal physiological functions. Excessive ROS are responsible for oxidative damage of DNA and lipids, which may lead to cellular death. Also, oxidative stress may provoke inflammatory responses that can further enhance oxidative stress. As a result, oxidative stress can act to precipitate chronic inflammation, with pathological conditions triggering various disorders including cardiovascular diseases, metabolic syndrome, neurodegenerative disorders, and cancer.

Due to the role played by oxidative stress in the pathogenesis of various chronic diseases, it has been of increasing interest to assess adjuvant effects of antioxidant agents in food on prevention and alleviation of these diseases. The U.S. Food and Drug Administration has acknowledged hydrogen (H₂) gas as a food additive when used in potable water or other beverages and declared it to be generally recognized as safe. Hydrogen functions as an antioxidant and has been shown to selectively scavenge strong oxidants such as hydroxyl radical.

Hydrogen-enriched potable water is commercially available and commonly referred to as “hydrogen water.” Apparatuses to increase the hydrogen content of potable water or other beverages are commonly referred to as “hydrogen water generators.” Small scale hydrogen water generators for personal or home use typically generate hydrogen by electrolysis, using electricity to split water into hydrogen and oxygen. Large scale hydrogen water generators for commercial or industrial use typically receive hydrogen gas as an input and bubble the hydrogen gas through potable water to produce hydrogen water. Hydrogen gas is typically received from standard sized pressure storage cylinders, such as, for example, size 200 high pressure industrial cylinders (51 inches or 129.5 cm in length, with an outer diameter of 9 inches or 22.9 cm) or size 300 high pressure industrial cylinders (55 inches or 139.7 cm in length, with an outer diameter of 9.25 inches or 23.5 cm). Typical large scale hydrogen water generators are generally capable of producing hydrogen water with a H₂ content in the range of 0.7 ppm to 1.2 ppm, with the most efficient apparatuses producing hydrogen water with a H₂ content approaching 1.6 ppm.

The inventors of the present disclosure realized that improvements to the current systems and methods for adding hydrogen to potable water are needed to increase the H₂ content of potable water above 1.6 ppm, above 1.8 ppm, or above 2.0 ppm, to deliver a greater amount of hydrogen in a given volume of water. Certain preferred features of the present disclosure address these and other needs and provide other important advantages.

### SUMMARY

Systems and methods for improved hydrogenation of water include pre-cooling hydrogen prior to delivery of the hydrogen to a hydrogen water generator and using a manifold to combine the hydrogen output of multiple hydrogen-containing storage cylinders into a single fluid channel prior to delivery of the hydrogen to the hydrogen water generator.

In a first embodiment, the present invention includes a method of providing hydrogen gas to a hydrogen water generator, the method comprising cooling hydrogen gas in a plurality of hydrogen containers, combining the hydrogen gas from the plurality of hydrogen containers into a single fluid channel, and providing the cooled hydrogen gas to the hydrogen water generator via the single fluid channel. In some embodiments, the cooling step includes cooling the hydrogen gas to a temperature at or below 13° C., 55° F., 50° F., 10° C., 45° F., 5° C., 40° F., 35° F. or 1° C. In further embodiments, the cooling step includes exposing the plurality of hydrogen containers to a temperature at or below 13° C., 55° F., 50° F., 10° C., 45° F., 5° C., 40° F., 35° F. or 1° C. for at least twelve hours or at least twenty four hours. In certain embodiments, the combining step includes combining the hydrogen gas from the plurality of hydrogen containers into a single fluid channel using a manifold having a plurality of inlets, each in fluid communication with a different storage container in the plurality of hydrogen storage containers, and a single outlet in fluid communication with the hydrogen water generator via the single fluid channel. In some embodiments, the cooling occurs prior to the combining.

In a second embodiment, the present invention includes a method of generating hydrogen water, the method comprising cooling hydrogen gas in a plurality of hydrogen containers, combining the hydrogen gas from the plurality of hydrogen containers into a single fluid channel, providing the cooled hydrogen gas to a hydrogen water generator via the single fluid channel, and generating hydrogen water using the hydrogen water generator, wherein the generated hydrogen water has a hydrogen content of at least 1.6 ppm, at least 1.8 ppm or at least 2.0 ppm. In some embodiments, the cooling step includes cooling the hydrogen gas to a temperature at or below 13° C., 55° F., 50° F., 10° C., 45° F., 5° C., 40° F., 35° F. or 1° C. In further embodiments, the cooling step includes exposing the plurality of hydrogen containers to a temperature at or below 13° C., 55° F., 50° F., 10° C., 45° F., 5° C., 40° F., 35° F. or 1° C. for at least twelve hours or at least twenty four hours. In certain embodiments, the combining step includes combining the hydrogen gas from the plurality of hydrogen containers into a single fluid channel using a manifold having a plurality of inlets, each in fluid communication with a different storage container in the plurality of hydrogen storage containers, and a single outlet in fluid communication with the hydrogen water generator via the single fluid channel. In further embodiments, the cooling occurs prior to the combining.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 depicts a front perspective view of a plurality of hydrogen-containing storage cylinders positioned at least partially within an open-topped cylindrical storage container.

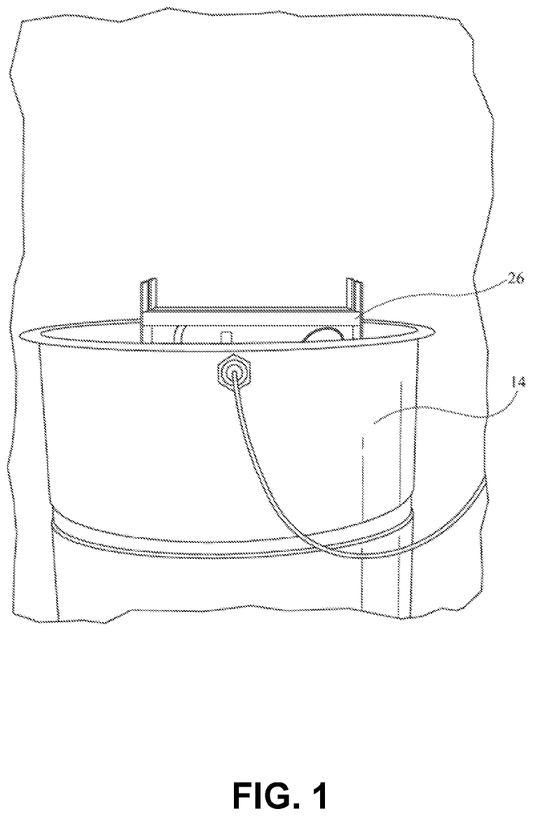

FIG. 2 depicts a top perspective view of the open-topped cylindrical storage container containing a plurality of hydrogen-containing storage cylinders and ice.

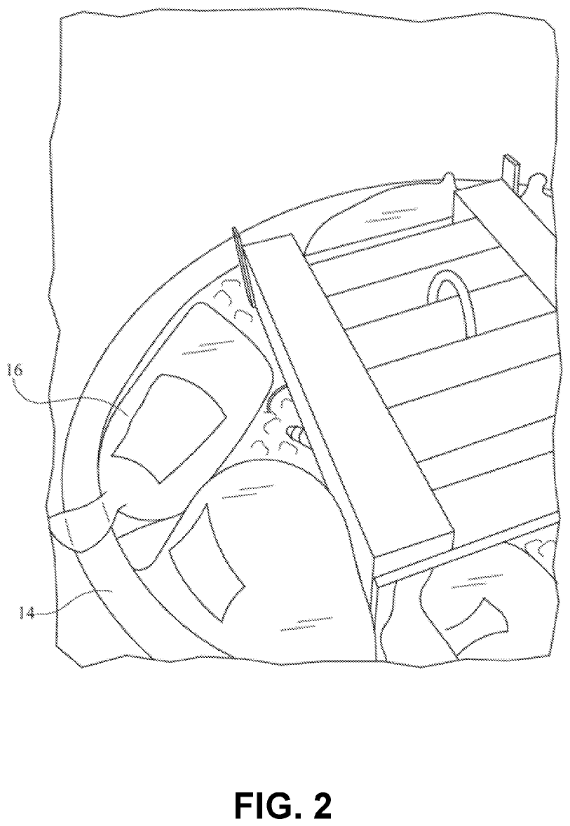

FIG. 3 depicts a perspective view of the plurality of hydrogen-containing storage cylinders positioned at least partially the open-topped cylindrical storage container.

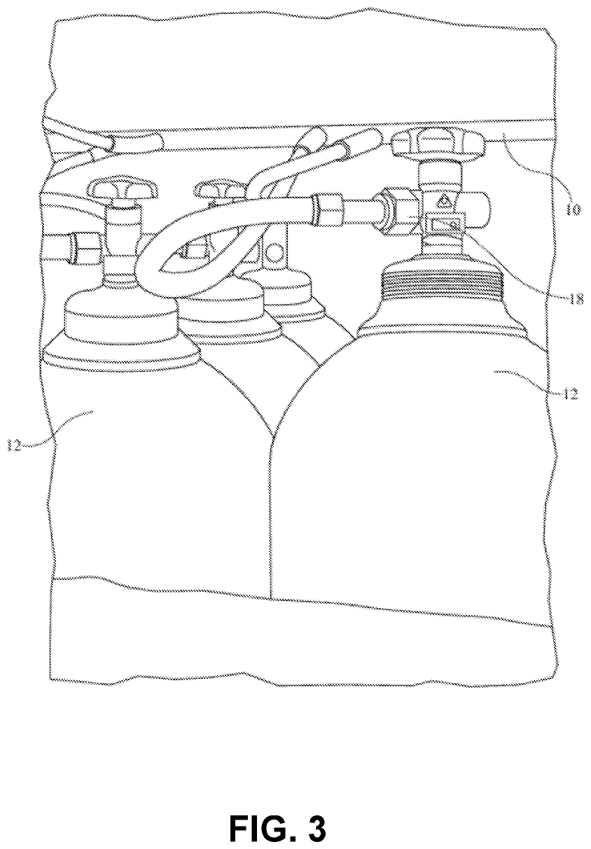

FIG. 4 depicts a perspective view of the plurality of hydrogen-containing storage cylinders inside the open-topped cylindrical storage container.

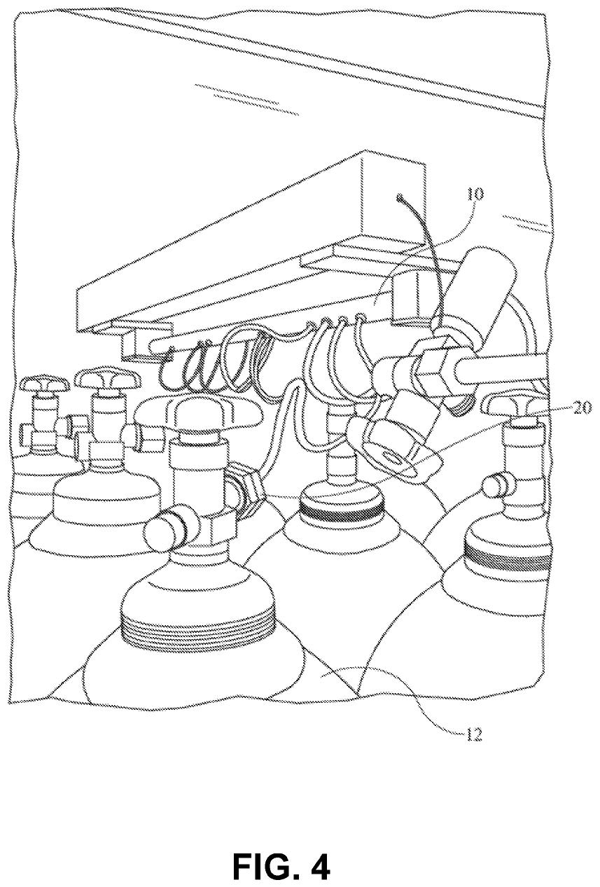

FIG. 5 depicts a bottom perspective view of the plurality of hydrogen-containing storage cylinders inside the open-topped cylindrical storage container.

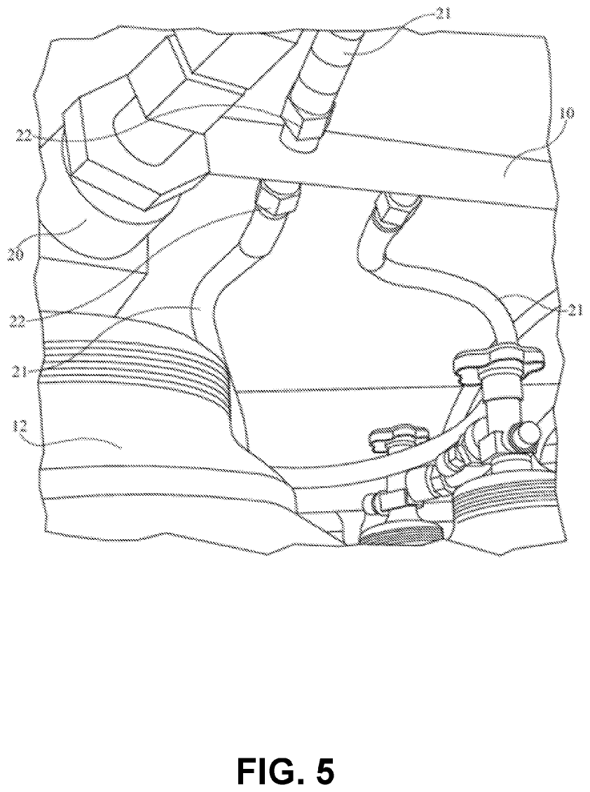

FIG. 6 depicts a perspective view of the plurality of hydrogen-containing storage cylinders positioned within a frame.

FIG. 7 is a close up view of the image of FIG. 6.

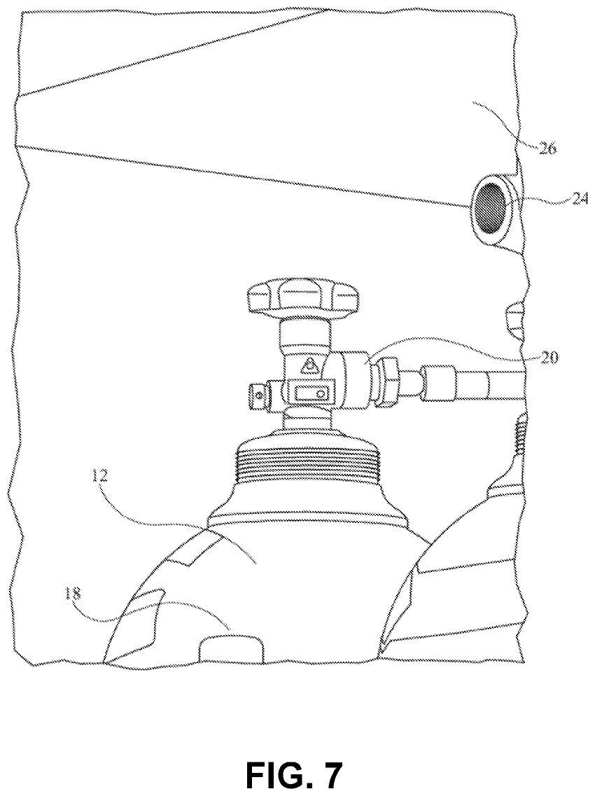

### DETAILED DESCRIPTION

For the purposes of promoting an understanding of the principles of the invention disclosed herein, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein; such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated. The terms “about” or “approximately,” unless otherwise defined, refer to a range within 10% of the most precise digit stated numerical value (e.g., “about 1” refers to a range from 0.9 to 1.1, while “about 1.1” refers to range from 1.09 to 1.11). The modifier “about” should also be considered as disclosing the range defined by the absolute values of the two endpoints. For example, the expression “from about 2 to about 4” also discloses the range “from 2 to 4.”

Embodiments of the present invention include pre-cooling hydrogen prior to delivery of the hydrogen to a hydrogen water generator and using a manifold 10 to combine the hydrogen output of a plurality of hydrogen-containing storage cylinders 12 into a single fluid channel prior to delivery of the hydrogen to the hydrogen water generator. The present invention is intended for use with a hydrogen gas-requiring hydrogen water generator, not an electrolysis-type hydrogen water generator.

In some embodiments, a plurality of hydrogen-containing storage containers, such as, for example, storage cylinders 12 are cooled to below ambient temperature. In some embodiment, the plurality of hydrogen-containing storage cylinders 12 are at least two, at least four, at least six, at least eight, at least ten, at least twelve, or at least sixteen hydrogen-containing storage cylinders 12. In a certain embodiment, twelve hydrogen-containing storage cylinders 12 are cooled to below ambient temperature. In some embodiments, the cylinders 12 and hydrogen stored therein are cooled to a temperature at or below 13° C., to a temperature at or below 55° F., to a temperature at or below 50° F., to a temperature at or below 10° C., to a temperature at or below 45° F., to a temperature at or below 5° C., to a temperature at or below 40° F., to a temperature at or below 35° F. or to a temperature at or below 1° C. In certain embodiments, the cylinders 12 are exposed to a temperature at or below 13° C., 55° F., 50° F., 10° C., 45° F., 5° C., 40° F., 35° F. or 1° C. for a period of at least twelve hours, at least eighteen hours, at least twenty four hours, about twenty four hours or greater than twenty fours hours to reduce the temperature of the hydrogen stored within the storage cylinders 12. The cooled hydrogen gas is then directed as input into a hydrogen water generator (not shown) for the production of hydrogen water.

In some embodiments, the plurality of hydrogen-containing storage cylinders 12 are positioned within an open-topped cylindrical storage container 14, then cooled by at least partially filling the storage container with ice 16 or other cooling substance to expose the storage cylinders to a temperature at or below 13° C., 55° F., 50° F., 10° C., 45° F., 5° C., 40° F., 35° F. or 1° C. In other embodiments, other cooling methods known in the art may be used.

In some embodiments, each hydrogen-containing storage cylinder 12 includes a cylindrical body 18 having a length, an outer diameter, and an interior for storing hydrogen gas and an outlet 20 attached to the body providing controllable fluid communication with the interior. The outlet 20 of each of the plurality of storage cylinders 12 is connected to a manifold 10, via a fluid transfer line 21, such as a tube, pipe, hose, or other means of fluid communication as generally known in the art. In one embodiment, the fluid transfer lines are ⅜″ diameter tubes, optionally flexible. The manifold 10 includes a plurality of inlets 22, each connected to an outlet 20 of a different storage cylinder 12 via a fluid transfer line 21, and a single outlet 24 configured for fluid communication with an input line of a hydrogen water generator (not shown), wherein the connection between the outlet 24 and the input line of the hydrogen water generator forms a single fluid channel between the manifold 10 and the hydrogen water generator.

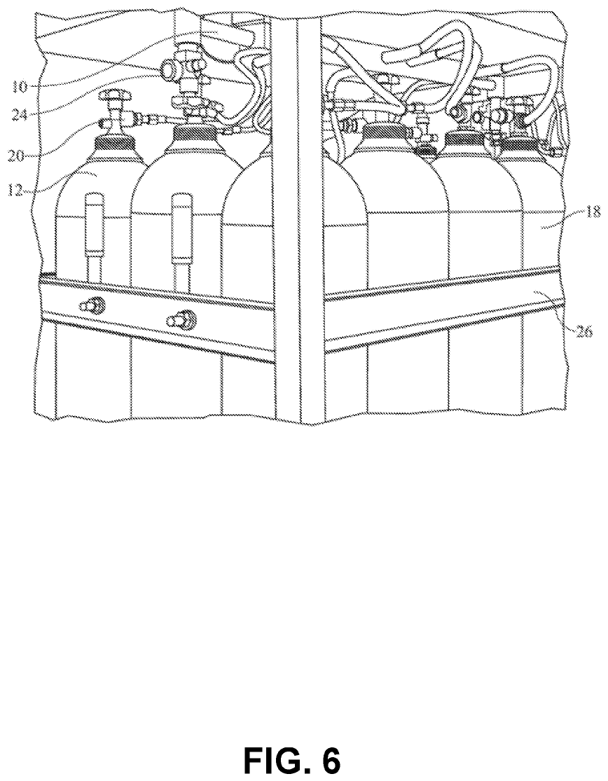

As most easily seen in FIG. 6, in some embodiments the plurality of storage cylinders 12 are positioned within a frame 26 which supports and surrounds the cylinders 12. In the depicted embodiment, the manifold 10 is attached to the frame 26. By positioning the cylinders 12 within the frame 26, users may readily insert all cylinders 12 into the storage container 14 or remove all cylinders 12 from the storage container by lifting or lowering the frame 26 using an overhead crane, forklift, hoist, or other means as generally known in the art.

A typical hydrogen water generator input line includes a means for limiting the maximum pressure (typically measured in pounds per square inch or psi) of incoming hydrogen gas. Accordingly, connecting a plurality of hydrogen-containing cylinders 12 via a manifold 10 and directing the hydrogen gas output of the plurality of cylinders 12 through a single outlet 24 to the input line is not expected to increase the pressure of the hydrogen gas received by the hydrogen water generator. However, the inventors unexpectedly found that this configuration, combined with cooling the hydrogen gas in the storage cylinders 12, resulted in increased hydrogen content in the resulting hydrogen water produced by the hydrogen water generator receiving hydrogen gas from this system, as indicated in Table I.

TABLE I
Hydrogen content of hydrogen water produced
by hydrogen water generator.

| Configuration | H₂ (ppm) |
|---|---|
| 12 tanks connected via manifold, cooled to | 2.0-3.5 |
| below 55° F. | |
| 12 tanks connected via manifold, room | 1.8-1.9 |
| temperature | |
| single tank, room temperature | Not exceeding 1.6 |

While the disclosed example discusses a plurality of hydrogen-containing storage cylinders 12 connected via a manifold 10 into a single outlet 24, in other embodiments the system may include a single hydrogen storage tank, which may or may not be cylindrical in shape, with an interior volume at least twice, at least four times, at six times, at least eight times, at least ten times, at least twelve times, or at least sixteen times the internal volume of a standard size 200 high pressure industrial cylinder or size 300 high pressure industrial cylinder

While examples, one or more representative embodiments, and specific forms of the disclosure, have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

What is claimed is:

1. A method of providing hydrogen gas to a hydrogen water generator, the method comprising:
cooling hydrogen gas in a plurality of hydrogen containers;
combining the hydrogen gas from the plurality of hydrogen containers into a single fluid channel; and
providing the cooled hydrogen gas to the hydrogen water generator via the single fluid channel.

2. The method of claim 1, wherein the cooling step includes cooling the hydrogen gas to a temperature at or below 55° F.

3. The method of claim 2, wherein the cooling step includes cooling the hydrogen gas to a temperature at or below 45° F.

4. The method of claim 1, wherein the cooling step includes exposing the plurality of hydrogen containers to a temperature at or below 55° F. for at least twelve hours.

5. The method of claim 4, wherein the cooling step includes exposing the plurality of hydrogen containers to a temperature at or below 45° F. for at least twelve hours.

6. The method of claim 4, wherein the cooling step includes exposing the plurality of hydrogen containers to a temperature at or below 55° F. for at least twenty four hours.

7. The method of claim 1, where the combining step includes combining the hydrogen gas from the plurality of hydrogen containers into a single fluid channel using a manifold having a plurality of inlets, each in fluid communication with a different storage container in the plurality of hydrogen storage containers, and a single outlet in fluid communication with the hydrogen water generator via the single fluid channel.

8. The method of claim 1, wherein the cooling occurs prior to the combining.

9. A method of generating hydrogen water, the method comprising:
cooling hydrogen gas in a plurality of hydrogen containers;
combining the hydrogen gas from the plurality of hydrogen containers into a single fluid channel;
providing the cooled hydrogen gas to a hydrogen water generator via the single fluid channel; and
generating hydrogen water using the hydrogen water generator;
wherein the generated hydrogen water has a hydrogen content of at least 1.6 ppm.

10. The method of claim 9, wherein the generated hydrogen water has a hydrogen content of at least 2.0 ppm.

11. The method of claim 9, wherein the cooling step includes cooling the hydrogen gas to a temperature at or below 55° F.

12. The method of claim 11, wherein the cooling step includes cooling the hydrogen gas to a temperature at or below 45° F.

13. The method of claim 12, wherein the cooling step includes cooling the hydrogen gas to a temperature at or below 35° F.

14. The method of claim 9, where the combining step includes combining the hydrogen gas from the plurality of hydrogen containers into a single fluid channel using a manifold having a plurality of inlets, each in fluid communication with a different storage container in the plurality of hydrogen storage containers, and a single outlet in fluid communication with the hydrogen water generator via the single fluid channel.

15. The method of claim 9, wherein the cooling occurs prior to the combining.
